(19) United States
(12) Patent Application Publication
(10) Pub. No.: US 2024/0119292 A1
(43) Pub. Date: Apr. 11, 2024

(54) COMPUTER-READABLE RECORDING MEDIUM STORING MACHINE LEARNING PROGRAM, INFORMATION PROCESSING DEVICE, AND MACHINE LEARNING METHOD

(71) Applicant: Fujitsu Limited, Kawasaki-shi (JP)

(72) Inventor: Yuichi KAMATA, Isehara (JP)

(73) Assignee: Fujitsu Limited, Kawasaki-shi (JP)

(21) Appl. No.: 18/234,883

(22) Filed: Aug. 17, 2023

(30) Foreign Application Priority Data
Oct. 7, 2022 (JP) 2022-162705

(51) Int. Cl. G06N 3/084

(52) U.S. Cl. CPC G06N 3/084

(57) ABSTRACT

A non-transitory computer-readable recording medium storing a machine learning program for causing a computer to execute a process to train a machine learning model constructed by combining a plurality of modules configured by a neural network, the process includes parsing dependency between words for a plurality of words included in a question sentence of training data that forms a set of an image and the question sentence related to the image, determining a weight to be applied to each of the plurality of modules, based on a result of the parsing, and controlling selection of a combination of modules to be used in the machine learning model from the plurality of modules, based on the weight to be applied to each of the plurality of modules.

### CROSS-REFERENCE TO RELATED APPLICATION

This application is based upon and claims the benefit of priority of the prior Japanese Patent Application No. 2022-162705, filed on Oct. 7, 2022, the entire contents of which are incorporated herein by reference.

### FIELD

The present embodiment discussed herein is related to a machine learning program and the like.

### BACKGROUND

A method of controlling a combination of neural modules (program) to perform machine learning is disclosed.

For example, in a first technique, a CLOSURE data set has been proposed in which phrases and clauses that constitute a question sentence of a CLEVR data set that is training data of machine learning are combined, and accuracy is evaluated by a question method that does not directly appear in the CLEVR data set. The CLEVR data set here refers to a data set of question sentences for content of a 3D rendering image. The CLOSURE data set refers to a data set for evaluating accuracy by a question method that does not directly appear in the CLEVR data set that is training data. For the CLOSURE data set, it is disclosed that the accuracy deteriorates in a test of a neural module network model after training with the CLEVR data set. Therefore, in the first technique, the accuracy in the CLOSURE data set is improved by applying a method of modulating an image feature amount with a sentence feature amount (FILM) to the neural module.

Note that FIG. 7 is reference diagrams illustrating a CLEVR and CLOSURE data set, and combinations of the neural modules. The left diagram of FIG. 7 is a reference diagram illustrating the CLEVR and CLOSURE data set. The right diagram of FIG. 7 is a reference diagram illustrating the combinations (programs) of neural modules. P1 illustrated in the right diagram of FIG. 7 is a combination (program) of modules in which phrases and clauses that constitute a question sentence Q1 of the CLEVR data set are neural modules. The parentheses under the modules are arguments. P2 is a combination (program) of modules in which phrases and clauses that constitute a question sentence Q2 of the CLEVR data set are neural modules. P1 and P2 are correct answers of the combinations (programs) of modules for the question sentences Q1 and Q2, respectively. P3 is a combination of modules in which phrases and clauses that constitute a question sentence Q3 of the CLOSURE data set are neural modules, and is a combination (program) of modules having a question method that does not appear in the question sentence of the CLEVR data set.

Furthermore, in a second technique, a neural module that trains each processing of a CLEVR program is prepared. In training processing, a weight for controlling a combination of module processing required for an answer to a request of an input question sentence is also automatically generated by training. Note that FIG. 8 is a reference diagram illustrating training of the CLEVR program. “find”, “transform”, . . . , “answer”, and “compare” illustrated in FIG. 8 are a combination of module processing, and a weight Wm for controlling the combination of module processing is also automatically generated by training.

In the first technique and the second technique, each neural module necessary for the answer to the input question sentence and the combination (program) of the modules are prepared in advance and trained at the time of training. For example, in the first technique and the second technique, the neural modules are configured and trained in accordance with the correct answer program for the question sentence at the time of training.

“CLOSURE Assessing Systematic Generalization of CLEVR Models”, arXiv:1912.05783 and “Explainable Neural Computation via Stack Neural Module Networks”, In:ECCV 2018 are disclosed as related art.

### SUMMARY

According to an aspect of the embodiments, a non-transitory computer-readable recording medium storing a machine learning program for causing a computer to execute a process to train a machine learning model constructed by combining a plurality of modules configured by a neural network, the process includes parsing dependency between words for a plurality of words included in a question sentence of training data that forms a set of an image and the question sentence related to the image, determining a weight to be applied to each of the plurality of modules, based on a result of the parsing, and controlling selection of a combination of modules to be used in the machine learning model from the plurality of modules, based on the weight to be applied to each of the plurality of modules.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a functional configuration of an information processing device according to an embodiment;

FIG. 2 is a diagram illustrating an example of dependency parsing according to the embodiment;

FIG. 3 is a diagram illustrating a method of generating a depended matrix according to the embodiment;

FIG. 4 is a diagram illustrating an example of a flow of machine learning according to the embodiment;

FIG. 5 is a diagram illustrating an example of a flowchart of machine learning processing according to the embodiment;

FIG. 6 is a diagram illustrating an example of a computer that executes a machine learning program;

FIG. 7 is a reference diagram illustrating a CLEVR and CLOSURE data set, and combinations of modules; and

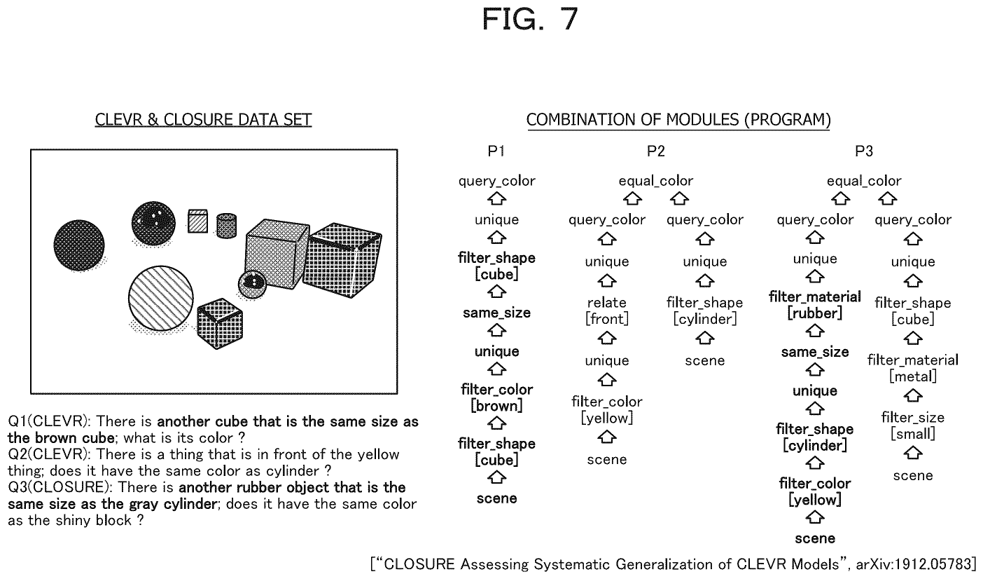

FIG. 8 is a reference diagram illustrating training of a CLEVR program.

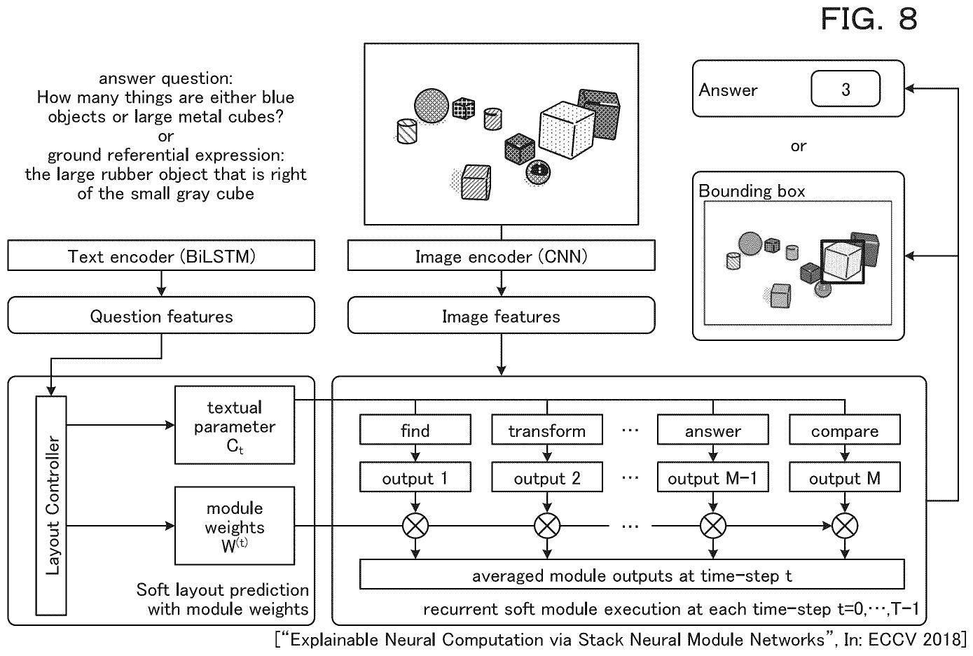

### DESCRIPTION OF EMBODIMENTS

In the first technique and the second technique, the combination (program) of correct answer modules for the question sentence needs to be prepared at the time of training. However, there is a problem that it is difficult to prepare in advance correct answers for the combinations (programs) of modules necessary for solving tasks (question sentences) as various inputs.

Hereinafter, embodiments of techniques of capable to improve recognition accuracy even for a sentence input that is not included in training data will be described in detail with reference to the drawings. Note that the present embodiment is not limited to the embodiments.

### EMBODIMENTS

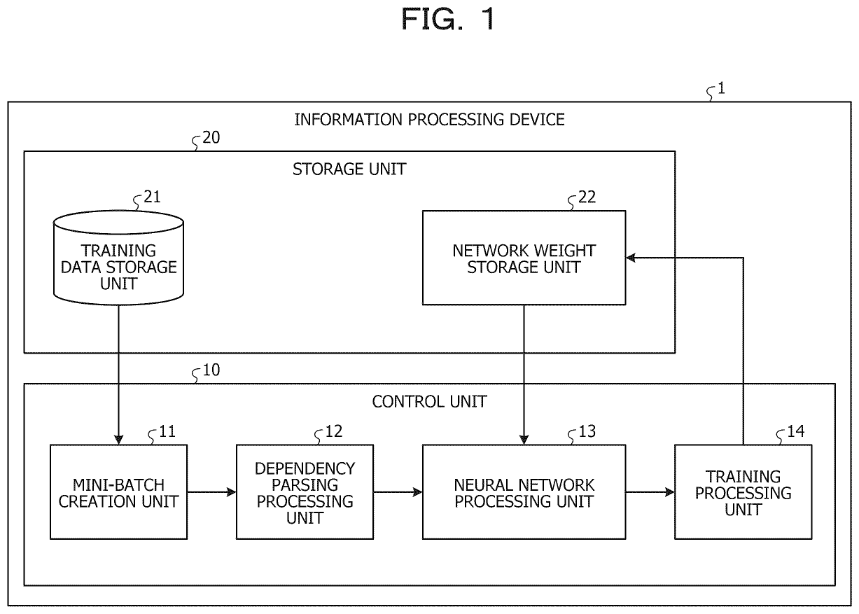

FIG. 1 is a block diagram illustrating an example of a functional configuration of an information processing device according to an embodiment. An information processing device 1 illustrated in FIG. 1 uses a result of parsing dependency of sentences included in training data when performing machine learning of a weight distribution that controls a combination of neural modules. Then, the information processing device 1 improves recognition accuracy for an input sentence configured by a combination of phrases and clauses in a sentence used during training even if the input sentence is not included in the training data during a test. For example, the information processing device 1 improves the recognition accuracy for the input sentence even if the input sentence is an input sentence of CLOSURE that is not included in CLEVR training data.

The information processing device 1 includes a control unit 10 and a storage unit 20. The control unit 10 includes a mini-batch creation unit 11, a dependency parsing processing unit 12, a neural network processing unit 13, and a training processing unit 14. The storage unit 20 includes a training data storage unit 21 and a network weight storage unit 22. Note that the dependency parsing processing unit 12 is an example of a parsing unit. The neural network processing unit 13 and the training processing unit 14 are examples of a determination unit and a control unit.

The training data storage unit 21 stores training data. The training data is training data including a question sentence, an image, and an answer as one data set. The question sentence is a sentence of a question for the image. For example, the question sentence is a question sentence for content of a 3D rendering image. An example of the question sentence in a case where the image is a 3D rendering image in which colored content such as cubes or cylinders is drawn includes “There is another cube that is the same size as the brown cube; what is the color?”.

The network weight storage unit 22 stores a weight of a neural network. Note that the network weight storage unit 22 is updated by the training processing unit 14.

The mini-batch creation unit 11 creates training data used in mini-batch training. For example, the mini-batch creation unit 11 acquires training data corresponding to a batch size to be used in the mini-batch training from the training data storage unit 21. The mini-batch training herein refers to a method of updating parameters to be used in training, and training is collectively performed with training data corresponding to the batch size, and the parameters such as weights are updated. The batch size is larger than 1 and smaller than the number of all the training data, and is determined in advance. The training data includes a question sentence, an image, and an answer.

The dependency parsing processing unit 12 parses dependency of a question sentence. For example, the dependency parsing processing unit 12 receives the training data created by the mini-batch creation unit 11 as an input for training. The dependency parsing processing unit 12 divides the question sentence of the training data into words. For the word division, for example, a morphological analysis may be used or any existing method may be used. The dependency parsing processing unit 12 parses depended information between words and dependency tag information using dependency parsing. A dependency tag mentioned herein refers to a tag indicating a relationship of phrases, clauses, and the like between words, and is used during the dependency parsing.

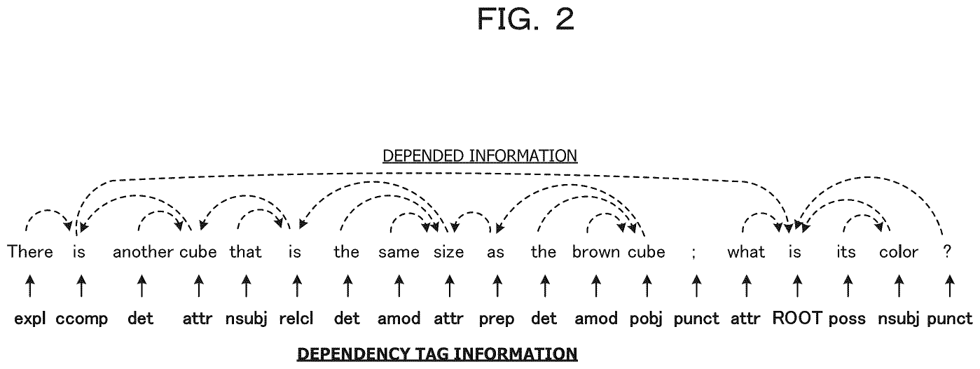

Here, an example of the dependency parsing will be described with reference to FIG. 2. FIG. 2 is a diagram illustrating an example of dependency parsing according to the embodiment. As illustrated in FIG. 2, “There is another cube that is the same size as the brown cube; what is the color?” is represented as a question sentence of the training data. Each word is divided by a blank. The dependency parsing processing unit 12 performs dependency parsing for the question sentence. Then, the dependency parsing processing unit 12 acquires the depended information and the dependency tag information by the dependency parsing. Here, as the depended information, an arrow represents dependency from a dependency source word to a dependency destination word. As an example, as the dependency tag information, the dependency tag of the word “there” indicating the dependency source is “expl”, which means “syntactic expletive”. The dependency tag of the word “is” indicating the dependency destination is “ccomp”, which means “complement sentence”. For example, it is meant (dependency relations) that the word “there” indicating the dependency source is syntactic expletive with respect to the word “is” indicating the dependency destination. The training processing unit 14 to be described below determines the weight of each neural module that constitutes the neural network, using a result of such dependency parsing. Note that, hereinafter, the “dependency destination” is referred to as a “depended” destination. The “dependency source” is referred to as a “dependent” source. Furthermore, the “neural module” may be referred to as a “module”.

Note that a list of the dependency tags is disclosed in, for example, “https://qiita.com/kei_0324/items/400f639b2f185b39a0cf” or “https://universaldependencies.org/u/dep/”.

Returning to FIG. 1, the neural network processing unit 13 processes a neural network.

For example, the neural network processing unit 13 converts each word of the question sentence received as an input into word embedding. Furthermore, the neural network processing unit 13 converts the dependency tag corresponding to each word parsed by the dependency parsing into respective dependency tag embedding. Embedding as used herein refers to conversion of a natural language into a computable form. The word embedding referred here is obtained by encoding a word in a vector space, and words having similar meanings are vectors having a close distance. The dependency tag embedding referred here is obtained by encoding the dependency tag in the vector space, and tags having similar meanings are vectors having a close distance.

Then, the neural network processing unit 13 adds the dependency tag embedding corresponding to each word to each word embedding and outputs a depended word embedding sequence. Then, the neural network processing unit 13 adds a linearly transformed value to embedding of a dependent word group to a position of embedding of each depended word, using the depended matrix in which depended destinations of words included in the question sentence parsed by the dependency parsing are represented by hard attention (hard attention) of “0” and “1”. Then, the neural network processing unit 13 adds a sequence indicating a result of adding dependent word embedding to the position of embedding of each depended word to the depended word embedding sequence to generate a word embedding sequence in which the dependency information is added. The generated word embedding sequence is a dependency word embedding sequence.

Then, the neural network processing unit 13 sets the number of neural modules to M, gives inputs to all the M modules configured by a Transformer block, and calculates outputs. Here, M is the number of modules necessary for training, and is determined by the neural network. Furthermore, the input here includes the dependency word embedding from the beginning to the end of the question sentence and an object feature amount generated from the image. The object feature amount is obtained by cutting out an object from an image and calculating a feature amount. Note that the object feature amount may be calculated using any method.

Then, the neural network processing unit 13 calculates a weight distribution for weighted averaging the outputs of the M modules by multilayer perceptron (MLP) processing from a special token (BOS token) representing the beginning of the input sentence. Then, the neural network processing unit 13 uses the weighted-averaged module output as an input to the next layer and repeats the MLP processing up to the final layer.

The training processing unit 14 trains the neural network. For example, the training processing unit 14 performs the MLP processing from the output of the final layer and outputs an answer. As an example, the training processing unit 14 outputs the answer as class classification from options prepared in advance for a question. Then, the training processing unit 14 trains the neural network by a back propagation method from an error between the output answer and a correct answer. Then, the training processing unit 14 updates a weight to be applied to each module of the neural network and stores the weight in the network weight storage unit 22.

Thereby, the training processing unit 14 may improve the recognition accuracy for an input sentence even if the input sentence is not in the training data as long as the input sentence is a new input sentence (question sentence) configured by a combination of phrases and clauses in the sentence included in the training data. For example, in the existing techniques, each module function necessary for solving a question sentence and a combination (program sequence) of the module functions need to be prepared in advance. To remove this constraint, the module functions automatically requested from the training data including the question sentence, image, and answer and the combination of the module functions need to be trained with a module group configured by a general-purpose neural network. Therefore, if there is information of the question sentence divided into clauses and phrases by the dependency parsing, the training processing unit 14 may specify that the new input sentence (question sentence) of a combination of modules (program sequence) not included in the training data is the same as the training data in units of phrases and clauses.

### Method of Generating Depended Matrix

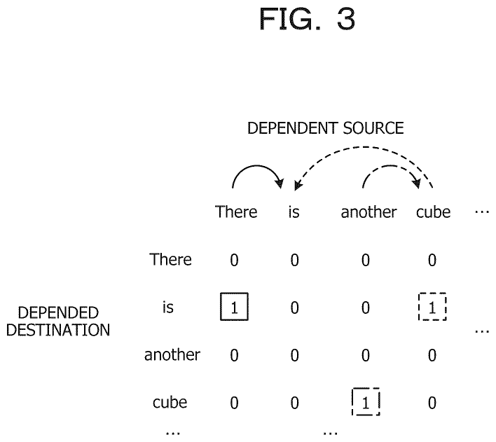

FIG. 3 is a diagram illustrating a method of generating a depended matrix according to the embodiment. As illustrated in FIG. 3, the depended matrix is a matrix in which the depended destinations of the words included in the question sentence are represented by hard attention (hard attention) of “0” and “1”. In the depended matrix, for each element, a column is set for the dependent word and a row is set for the depended word, and a matrix in which the row of the depended word and the column of the dependent word intersect is represented by “1”.

As an example, for the question sentence “There is another cube . . . ”, “there” is parsed as the dependent word and “is” is parsed as the depended word. Then, since the second row represents “is” and the first column represents “there”, “1” is set to the element of the second row and first column of the depended matrix. Furthermore, for the same question sentence, “cube” is parsed as the dependent word, and “is” is parsed as the depended word. Then, since the second row represents “is” and the fourth column represents “cube”, “1” is set to the element of the second row and fourth column of the depended matrix. Furthermore, for the same question sentence, “another” is parsed as the dependent word, and “cube” is parsed as the depended word. Then, since the fourth row represents “cube” and the third column represents “another”, “1” is set to the element of the fourth row and third column of the depended matrix.

The neural network processing unit 13 adds the value obtained by linearly transforming into embedding of the dependent word group to the position of the embedding of the depended word to generate the dependency word embedding in which the dependency information is added, using the depended matrix.

### Example of Flow of Machine Learning

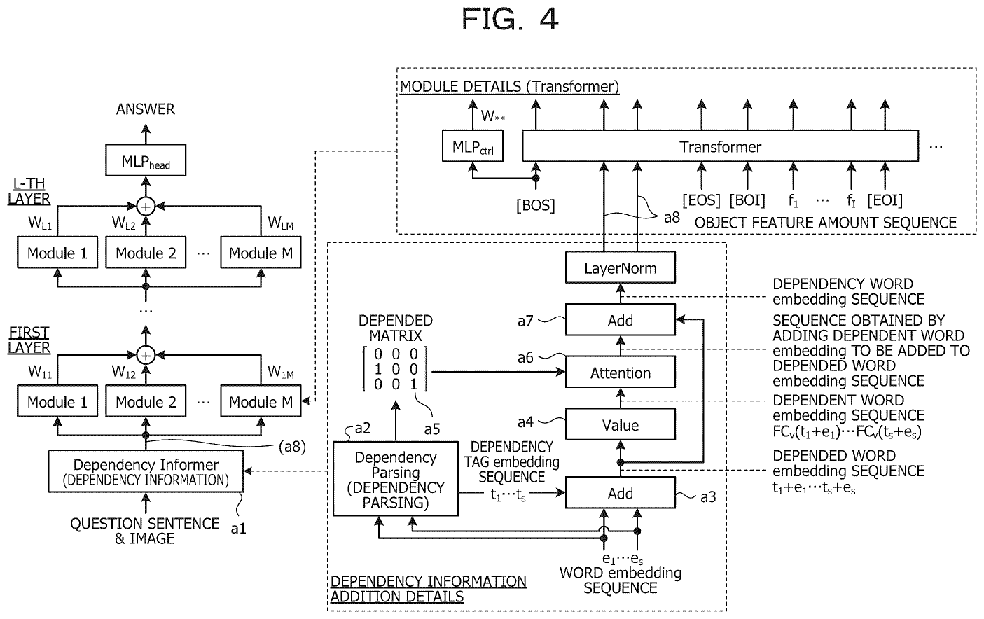

FIG. 4 is a diagram illustrating an example of a flow of machine learning according to the embodiment. As illustrated in FIG. 4, the dependency parsing processing unit 12 receives the training data including the question sentence and the image as the training data (a1). Here, the mini-batch creation unit 11 extracts the training data corresponding to the batch size to be used in the mini-batch training from the training data storage unit 21. Then, the dependency parsing processing unit 12 receives the training data corresponding to the batch size. Then, the following processing of a2 to a7 is performed for each training data corresponding to the batch size.

The dependency parsing processing unit 12 divides the question sentence into words, inputs the word embedding sequence, performs the dependency parsing between the words, and outputs the depended information between the words and the dependency tag information (a2).

Next, the neural network processing unit 13 adds the dependency tag embedding sequence to the word embedding sequence (a3). Then, the neural network processing unit 13 performs calculation processing using a matrix (value) for linearly transforming the depended word embedding sequence indicating the result of addition into embedding of the dependent word group, and output the dependent word embedding sequence (a4). Note that the linear transformation matrix (FCᵥ) of value is a matrix including parameters that are updated by training, and an initial value is a random number.

Furthermore, the neural network processing unit 13 generates the depended matrix, using the depended information between the words (a5). The depended matrix is a matrix in which the depended destinations of the words included in the question sentence and parsed by dependency parsing are represented by hard attention (hard attention) of 0 and 1.

Then, the neural network processing unit 13 multiplies the dependent word embedding sequence by the depended matrix in order to add only the embedding of the dependent word group for the depended word to the depended word embedding sequence at reference code a7 (a6). For example, it is assumed that the word embedding sequence is (e1, . . . , es) and the dependency tag embedding sequence is (t1, . . . , ts). It is assumed that the depended matrix is the matrix illustrated in FIG. 3. Then, the dependent word embedding sequence is calculated as (FCᵥ(t1+e1), . . . , FCᵥ(ts+es)). Then, the result of multiplying the depended matrix by the dependent word embedding sequence is calculated as (0, FCᵥ(t2+e2)+FCᵥ(t4+e4), 0, FCᵥ(t3+e3), . . . ). For example, since the position of “1” specified in the depended matrix is the position of the depended word for the dependent word, the embedding sequence of the dependent word is added to this position in advance.

Then, the neural network processing unit 13 adds the dependent word embedding sequence, which has been added to the position specified in the depended matrix, to the depended word embedding sequence (a7). As a result, the dependency word embedding sequence is generated. Assume that in the case where the depended matrix is the matrix illustrated in FIG. 3, the dependency word embedding sequence is the embedding sequence having “There”, “There is cube”, “another”, “another cube is”, . . . as each element as an image.

Then, the neural network processing unit 13 normalizes the dependency word embedding sequence generated from the training data corresponding to the batch size by layer normalization (LayerNorm) and outputs the normalized dependency word embedding sequence.

Next, the neural network processing unit 13 sets the number of modules to M, and inputs the dependency word embedding sequence whose output has been normalized by LayerNorm to all the M modules in the first layer configured by the Transformer block. In addition, the neural network processing unit 13 inputs an object feature amount sequence generated from the image to all the M modules in the first layer (a8). Here, the dependency word embedding from the beginning (BOS) to the end (EOS) of the dependency word embedding sequence is input. The object feature amounts from the beginning (BOI) to the end (BOE) of the object feature amount sequence are input.

Then, the neural network processing unit 13 calculates the weight distribution for weighted averaging the outputs of the M modules by the multilayer perceptron (MLP) processing from the special token (BOS token) representing the beginning of the input sentence. Then, the neural network processing unit 13 uses the weighted-averaged output as an input to the next layer and repeats the MLP processing up to the L-th layer.

Then, the training processing unit 14 performs the MLP processing (MLP_{head}) from the output of the final L layer and outputs the answer as class classification from options. Then, the training processing unit 14 trains the neural network by a back propagation method from an error between the output answer and a correct answer. Then, the training processing unit 14 updates a weight to be applied to each module of the neural network and stores the weight in the network weight storage unit 22.

Then, the mini-batch creation unit 11, the dependency parsing processing unit 12, the neural network processing unit 13, and the training processing unit 14 repeat the learning processing a specified number of times, update the weight to be applied to each module of the neural network, and store the updated weight in the network weight storage unit 22.

Thereafter, in the training processing unit 14, the trained MLP_{ctrl} selects a combination of modules according to the input training data and the weight applied to each module.

### Flowchart of Machine Learning Processing

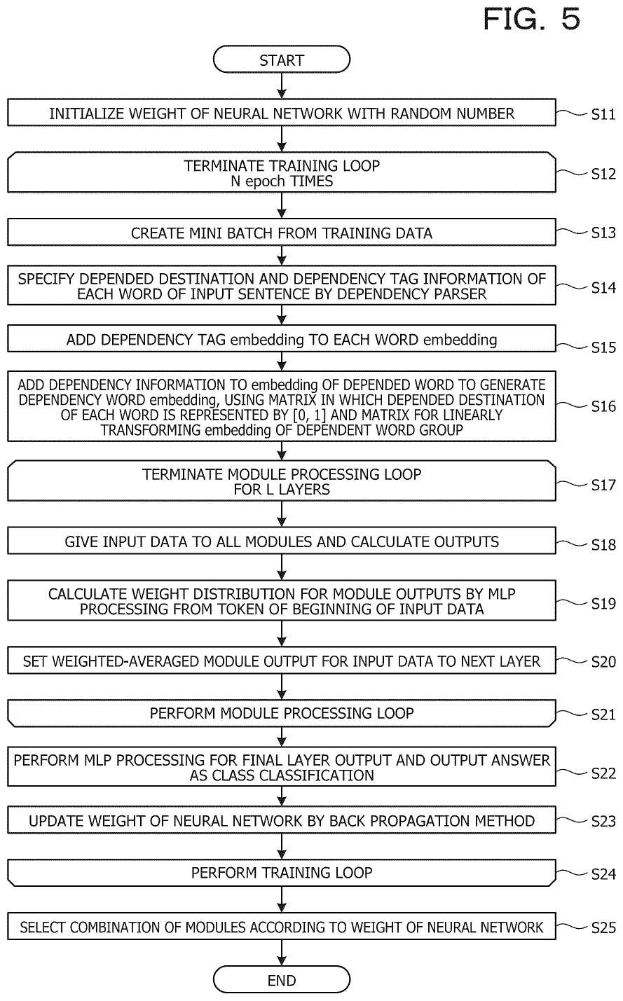

Here, an example of a flowchart of machine learning processing performed by the information processing device 1 will be described with reference to FIG. 5. FIG. 5 is a diagram illustrating an example of a flowchart of machine learning processing according to the embodiment. As illustrated in FIG. 5, the information processing device 1 initializes the weight of the neural network with a random value (operation S11). The information processing device 1 repeats operations S13 to S23, which are a training loop, a specified number of times of Nepoch (operations S12 and S24).

The information processing device 1 creates the mini batch from the training data (operation S13). For example, the mini-batch creation unit 11 acquires the training data corresponding to the batch size to be used in the mini-batch training from the training data storage unit 21. The information processing device 1 specifies the depended destination and the dependency tag information of each word of the input sentence (question sentence) by the dependency parsing, for the training data for which the mini batch has been created (operation S14).

The information processing device 1 adds the dependency tag embedding to each word embedding (operation S15) to generate the depended word embedding sequence.

Then, the information processing device 1 adds the dependency information to the embedding of the depended word to generate dependency word embedding, using the depended matrix in which the depended destination of each word is represented by “0” and “1”, and the matrix for linearly transforming the embedding of the dependent word group (operation S16). For example, the information processing device 1 multiplies the depended word embedding sequence by the matrix (value) for linearly transforming embedding of the dependent word group to output the dependent word embedding sequence. Furthermore, the information processing device 1 generates the depended matrix, using the depended information between the words. Then, the information processing device 1 multiplies the depended matrix by the dependent word embedding sequence and adds only the dependent word group to the position of the depended word specified by the depended matrix in advance. Then, the information processing device 1 adds the dependent word embedding sequence added in advance to the depended word embedding sequence. As a result, the dependency word embedding sequence is generated.

Next, the information processing device 1 repeats operations S18 to S20, which is the loop of the module processing, for L layers (operations S17 and S21). The information processing device 1 gives input data (the dependency word embedding sequence and the object feature amount) to all the modules and calculates outputs (operation S18). The information processing device 1 calculates the weight distribution for the module output by the MLP processing from the token of the beginning of the input data (operation S19). Then, the information processing device 1 sets the weighted-averaged module output as input data to the next layer (operation S20).

Then, when the module processing for the L layers is completed, the information processing device 1 performs the MLP processing for the output of the final layer and outputs the answer as the class classification (operation S22). Then, the information processing device 1 updates the weight of the neural network by the back propagation method (operation S23).

Then, when the training loop is completed the specified number of times of Nepoch, the information processing device 1 selects a combination of modules according to the weight of the neural network (operation S25). Then, the information processing device 1 terminates the machine learning processing.

### Effects of Embodiments

According to the above-described embodiment, in training of a machine learning model constructed by combining a plurality of modules configured by a neural network, the information processing device 1 parses dependency between words for a plurality of words included in a question sentence of training data including an image and the question sentence related to the image as a set. The information processing device 1 determines a weight to be applied to each of the plurality of modules based on a result of the parsing. The information processing device 1 controls selection of a combination of modules to be used in the machine learning model from the plurality of modules based on the weight to be applied to each of the plurality of modules. According to such a configuration, the information processing device 1 may improve the recognition accuracy for a sentence input that is a combination of dependency (phrases and clauses) between words included in the training data but the sentence input that is not included in the training data, using dependency between the words in the training data for training.

Furthermore, according to the above-described embodiment, the information processing device 1 specifies a depended destination and dependency tag information of each word included in the question sentence, using dependency parsing. The information processing device 1 adds embedding of the dependency tag for each word to embedding of each word. Then, the information processing device 1 adds a value obtained by linearly transforming the embedding of the dependent word group to the position of embedding of each depended word, using a matrix representing a depended position of each word included in the question sentence, and adds the added sequence to the embedding sequence of the depended word to generate the dependency word embedding sequence in which the dependency information is added. According to such a configuration, the information processing device 1 may generate the dependency word embedding sequence in which the dependency information is added by generating a sequence of embedding of the depended word to be added to the embedding sequence of the dependent word, using the matrix representing the depended position of each word included in the question sentence.

Furthermore, according to the above-described embodiment, the information processing device 1 inputs the dependency word embedding sequence and the object feature amount of the image to each of the plurality of modules configured by the transformer block and calculates the outputs, and performs the weighted averaging for the outputs of the plurality of modules in the MLP processing. The information processing device 1 performs processing for a predetermined number of layers using the weighted-averaged output as an input to the next layer. The information processing device 1 performs the MLP processing for the output of the final layer and outputs the answer. Then, the information processing device 1 trains the neural network by the back propagation method and determines the weight to be applied to each module. According to such a configuration, the information processing device 1 may train weights of a plurality of modules configured by a transformer block, and may select a combination of modules based on the weights of the modules.

Note that each illustrated configuration element of the information processing device 1 does not necessarily have to be physically configured as illustrated in the drawings. For example, specific forms of distribution and integration of the information processing device 1 are not limited to the illustrated ones, and the whole or a part of the information processing device 1 may be configured by being functionally or physically distributed and integrated in any units according to various loads, use states, or the like. Furthermore, the storage unit 20 may be coupled through a network as an external device of the information processing device 1.

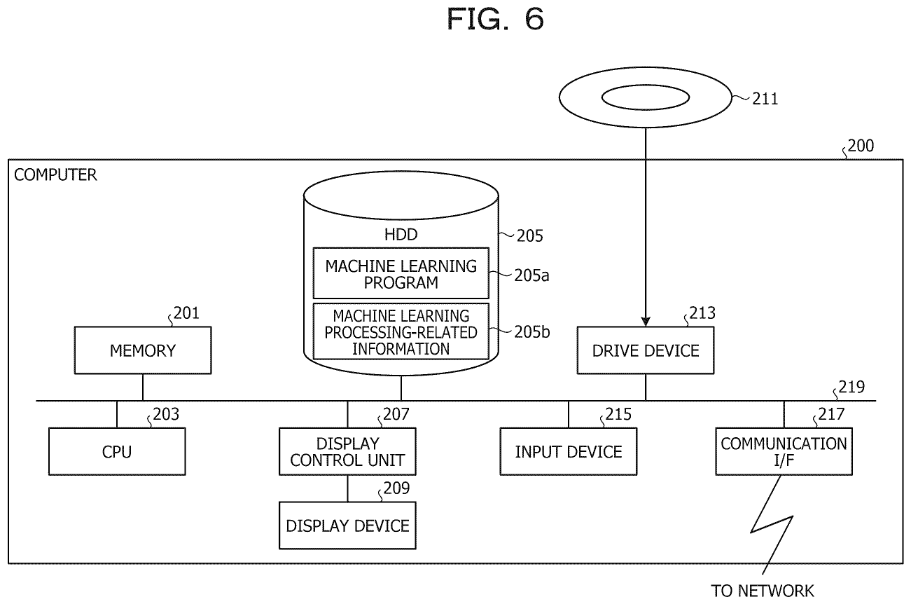

Furthermore, various types of processing described in the above embodiment may be implemented by a computer such as a personal computer or a workstation executing programs prepared in advance. Thus, in the following, an example of a computer that executes a machine learning program that implements functions similar to the functions of the information processing device 1 illustrated in FIG. 1 will be described. Here, the machine learning program that implements functions similar to the functions of the information processing device 1 will be described as an example. FIG. 6 is a diagram illustrating an example of a computer that executes a machine learning program.

As illustrated in FIG. 6, a computer 200 includes a central processing unit (CPU) 203 that executes various types of arithmetic processing, an input device 215 that accepts data input from a user, and a display device 209. Furthermore, the computer 200 includes a drive device 213 that reads a program and the like from a storage medium, and a communication interface (I/F) 217 that exchanges data with another computer via a network. Furthermore, the computer 200 further includes a memory 201 that temporarily stores various types of information, and a hard disk drive (HDD) 205. Then, the memory 201, the CPU 203, the HDD 205, the display control unit 207, the display device 209, the drive device 213, the input device 215, and the communication I/F 217 are coupled by a bus 219.

The drive device 213 is, for example, a device for a removable disk 211. The HDD 205 stores a machine learning program 205a and machine learning processing-related information 205b. The communication I/F 217 manages an interface between the network and the inside of the device, and controls input and output of data from the another computer. For example, a modem, a local area network (LAN) adapter, or the like may be adopted as the communication I/F 217.

The display device 209 is a display device that displays data such as a document, an image, or functional information, as well as a cursor, an icon, or a tool box. For example, a liquid crystal display or an organic electroluminescence (EL) display may be adapted as the display device 209.

The CPU 203 reads the machine learning program 205a, loads the read program into the memory 201, and executes the loaded program as a process. Such a process corresponds to each functional unit of the information processing device 1. The machine learning processing-related information 205b includes, for example, the training data storage unit 21 and the network weight storage unit 22. Then, for example, the removable disk 211 stores each piece of information such as the machine learning program 205a.

Note that the machine learning program 205a does not necessarily have to be stored in the HDD 205 from the beginning. For example, the program may be stored in a “portable physical medium” such as a flexible disk (FD), a compact disc read only memory (CD-ROM), a digital versatile disc (DVD), a magneto-optical disk, or an integrated circuit (IC) card inserted in the computer 200. Then, the computer 200 may read the machine learning program 205a from these media and execute the read program.

Furthermore, the machine learning processing performed by the information processing device 1 described in the above embodiment may be applied to an image search application using a natural language as a query. For example, the machine learning processing may be applied to an image search application to which a question (query) for an image and the image are input and which searches for a target object.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process to train a machine learning model constructed by combining a plurality of modules configured by a neural network, the process comprising:
parsing dependency between words for a plurality of words included in a question sentence of training data that forms a set of an image and the question sentence related to the image;
determining a weight to be applied to each of the plurality of modules, based on a result of the parsing; and
controlling selection of a combination of modules to be used in the machine learning model from the plurality of modules, based on the weight to be applied to each of the plurality of modules.

2. The non-transitory computer-readable recording medium according to claim 1,
wherein, in the parsing of the dependency, the process specifies a depended destination and dependency tag information of each of the plurality of words included in the question sentence, and
wherein, in the determining of the weight, the process
adds embedding of a dependency tag for each word to embedding of each word,
adds a value obtained by linearly transforming of information of a dependent word group to a position of embedding of each depended word, by using a matrix that represents a depended position of each word included in the question sentence,
adds an added sequence that indicates a result of adding embedding of a dependent word of the dependent word group to the position of embedding of each depended word to an embedding sequence of the depended word, and
generates an embedding sequence of a dependency word in which dependency information is added, and
wherein the process determines a weight to be applied to each of the plurality of modules, by using the embedding sequence of the dependency word.

3. The non-transitory computer-readable recording medium according to claim 2,
wherein, in the determining of the weight, the process
inputs the embedding sequence of the dependency word and an object feature amount of the image to each of the plurality of modules, and obtains an output responding to the input,
weighted-averages the outputs of the plurality of modules by MLP processing, and
performs processing for a predetermined number of layers, by using a weighted-averaged output as an input to a next layer, and
wherein the process
performs the MLP processing for an output of a final layer, and outputs an answer, and
trains the neural network by a back propagation method, and determines a weight to be applied to each module.

4. An information processing device to execute a process to train a machine learning model constructed by combining a plurality of modules configured by a neural network, the information processing device comprising:
a memory; and
a processor coupled to the memory and configured to:
parse dependency between words for a plurality of words included in a question sentence of training data that forms a set of an image and the question sentence related to the image;
determine a weight to be applied to each of the plurality of modules, based on a result of the parsing; and
control selection of a combination of modules to be used in the machine learning model from the plurality of modules, based on the weight to be applied to each of the plurality of modules.

5. A machine learning method for causing a computer to execute a process to train a machine learning model constructed by combining a plurality of modules configured by a neural network, the process comprising:
parsing dependency between words for a plurality of words included in a question sentence of training data that forms a set of an image and the question sentence related to the image;
determining a weight to be applied to each of the plurality of modules, based on a result of the parsing; and
controlling selection of a combination of modules to be used in the machine learning model from the plurality of modules, based on the weight to be applied to each of the plurality of modules.
